(19) United States
(12) Patent Application Publication
(10) Pub. No.: US 2026/0183809 A1
(43) Pub. Date: Jul. 2, 2026

(54) CLEANING APPARATUS, TREATMENT APPARATUS AND METHOD FOR RESPECTIVELY CLEANING AND TREATING POT-SHAPED HOLLOW BODIES, IN PARTICULAR TRANSPORTING CONTAINERS FOR SEMICONDUCTOR WAFERS OR FOR LITHOGRAPHY MASKS

(71) Applicant: GSEC GERMAN SEMICONDUCTOR EQUIPMENT COMPANY GMBH, Radolfzell am Bodensee (DE)

(72) Inventors: Lutz Rebstock, Gaienhofen (DE); Herve Guichardaz, Rielasingen-Worblingen (DE)

(21) Appl. No.: 19/129,731

(22) PCT Filed: Oct. 19, 2023
(86) PCT No.: PCT/EP2023/079134

§ 371 Date: May 14, 2025

(30) Foreign Application Priority Data
Nov. 17, 2022 (DE) 10 2022 130 420.5

(51) Int. Cl. B08B 9/28; B08B 9/20; B08B 13/00; B25J 11/00

(52) U.S. Cl. CPC B08B 9/28; B08B 9/205; B08B 13/00; B08B 2209/08; B25J 11/0095

(57) ABSTRACT

A cleaning device (44) for cleaning pot-shaped hollow bodies (12), wherein the cleaning device (44) comprises at least one side wall (46) that bounds a cleaning space (50), wherein the side wall (46) forms at least one device opening (48) by which the hollow body (12) closed by the cover (30) can be introduced into the cleaning space (50) by means of a gripping and moving device (18) for cleaning the outer hollow body surface (32), and at least one supply device (52) for supplying a cleaning fluid to the outer hollow body surface (32) of the hollow body (12) closed by the cover (30), wherein the device opening (48) is configured such that the gripping and moving device (18) projects at least partially into the cleaning space (50) or terminates flush with the device opening (48) at least during the supply of the cleaning fluid.

The present invention relates to a cleaning device for cleaning pot-shaped hollow bodies, in particular transport containers for semiconductor wafers or for lithography masks. Furthermore. the present invention relates to a treatment device and to a method for treating pot-shaped hollow bodies, in particular transport containers for semiconductor wafers or for lithography masks.

The manufacture of highly integrated electronic circuits and other sensitive semiconductor components takes place today in factories in which so-called semiconductor wafers run through a large number of processing steps. A large part of these processing steps takes place in clean rooms that are kept free of contaminants, in particular free of particles, with a high effort. Such a complex processing is necessary since particles that come into contact with the semiconductor material of the semiconductor wafers can in particular influence the material properties of the semiconductor wafers such that a total production batch becomes defective and unusable and has to be scrapped.

Since the keeping clean is becoming more and more important as the integration density of the semiconductor circuits and the effort to keep clean increase exponentially as the size of the clean rooms increases, the semiconductor wafers are not transported from one processing station to the next in an “open” state. Special transport containers (so-called FOUPs, front opening unified pods) are used instead. They are understood as box-shaped transport containers into which a large number of semiconductor wafers is inserted. The FOUPs are typically closed by a removable cover. Without the cover the FOUPs have a pot-shaped basic shape with a rectangular base surface. When the FOUPs are closed by their covers, the inserted semiconductor wafers can be transported from one clean room to another clean room protected from the environment. When the FOUPs have reached a processing station, they are opened, the semiconductor wafers are removed, and are processed accordingly. After processing has taken place, the semiconductor wafers are transported back into the FOUPs and are then conveyed to the next processing station.

Due to the high production downtimes on contaminations of the semiconductor wafers, it is necessary to clean the FOUPs from time to time. The FOUPs are in particular contaminated by the wear debris of the semiconductor wafers on the introduction into and the removal from the FOUPs.

The same applies accordingly to transport containers of lithography masks, for example of EUV lithography masks (“extreme ultraviolet radiation”). The EUV lithography masks are used to manufacture very small integrated circuits. The lithography masks, like the semiconductors, also have to be transported, with a similar situation arising. When FOUPs are spoken of in the following, the statements in this respect apply equally to transport containers for lithography masks.

Devices for cleaning FOUPs are known, for example, from U.S. Pat. No. 5,238,703 A, WO 2005/001888 A2, DE 10 2020 129 469 A1 and EP 1 899 084 B1.

With such devices, the FOUPs are cleaned both on their inner surfaces and on their outer surfaces. The FOUPs are typically contaminated much more on their outer surfaces than on their inner surfaces. As a result, the cleaning fluid accumulates both particles that originate from the outer surfaces and particles that originate from the inner surfaces during the cleaning procedure. The particles can therefore be transported from the outer surfaces to the inner surfaces. A satisfactory cleaning result is, however, only achieved when the number of particles has fallen below a certain value. Due to the particles originating from the outer surface, the cleaning procedure has to be carried out for a correspondingly long time period to be able to remove a sufficient portion of the particles. This is disadvantageous to the extent that, on the one hand, the amount of the required cleaning fluid is comparatively high and, on the other hand, the FOUPs cannot be used to transport the semiconductor wafers during the cleaning process. The production of the semiconductor wafers is hereby made more expensive.

In the already mentioned DE 10 2020 129 469 A1, both the outer surface and the inner surface can be cleaned in the same cleaning device. A first cleaning head is used for cleaning the inner surface and a second cleaning head is used for cleaning the outer surface. The cover is here separated from the remaining FOUP and the FOUP is placed onto a support wall of the cleaning device such that the FOUP is sealed with respect to the support wall. The first cleaning head here projects into the inner space of the FOUP. The second cleaning head is formed in U shape and is rotatably supported about an axis of rotation in the side wall of the cleaning device. Whereas the cleaning fluid that is used for cleaning the inner surface can be conducted in a defined manner, this is not directly the case with the cleaning fluid that is used for cleaning the outer surface. To prevent an uncontrolled distribution of the cleaning fluid used to clean the outer surface, a covering is provided that surrounds the FOUP and the second cleaning head once the FOUP has been placed onto the support wall. The covering and the mechanism for opening and closing the covering require a relatively high apparatus effort. As mentioned, the outer surface of an FOUP is typically contaminated more than the inner surface. However, since the FOUP is mostly closed by the cover, the demands on the cleaning of the inner surface are considerably greater than those made on the cleaning of the outer surface. To this extent, the apparatus effort for the cleaning of the outer surface of the FOUP is not proportionate to the demands made in some applications. In some applications, the cleaning of the outer surface is therefore dispensed with. However, since the risk of producing defective and unusable product batches of semiconductor wafers is hereby increased, the dispensing of the cleaning of the outer surface is also not optimal.

It is an object of an embodiment of the present invention to propose a cleaning device and a treatment device by which it is possible using simple and inexpensive means to provide a remedy for the above-named disadvantages and in particular to clean the outer surface of the hollow bodies with a small apparatus effort. It is furthermore the underlying object of an embodiment of the present invention to provide a corresponding method of cleaning the outer surface of the hollow body.

This object is achieved by the features specified in claims 1, 14 and 18. Advantageous embodiments are the subject of the dependent claims.

An embodiment of the invention relates to a cleaning device for cleaning pot-shaped hollow bodies, in particular transport containers for semiconductor wafers or for lithography masks, wherein
the hollow body comprises a hollow body wall that
   forms a hollow body opening that is closable or closed by a cover; and
   forms an outer hollow body surface, wherein
the cleaning device
   comprises at least a side wall that bounds a cleaning space, wherein
   the side wall forms at least a device opening by which the hollow body closed by the cover for cleaning the outer hollow body surface can be introduced into the cleaning space by means of a gripping and moving device, and
   comprises at least a supply device for supplying a cleaning fluid to the outer hollow body surface of the hollow body closed by the cover, wherein
the device opening is configured such that the gripping and moving device projects at least partially into the cleaning space or terminates flush with the device opening at least during the supply of the cleaning fluid, and/or
a placement device is arranged in the cleaning space on which the gripping and moving device can place the hollow body closed by the cover for supplying the cleaning fluid.

A substantial aspect of the cleaning device in accordance with the proposal is that the outer hollow body surface of the hollow body can be cleaned when it is closed by the cover. To this extent, the necessity of separating the cover from the remaining hollow body for this purpose is dispensed with, whereby time can correspondingly be saved. The cleaning of the outer hollow body surface can furthermore take place when the gripping and moving device is connected to the hollow body. A placement in a defined position is therefore not necessary. The gripping and moving device can move the hollow body translatorily or rotationally within certain limits during the cleaning of the outer hollow body surface so that the cleaning fluid used can also reach points that are difficult to access.

Where desired, the cleaning device can be provided with a placement device on which the hollow body closed by the cover can be placed. The connection between the hollow body and the gripping and moving device can be released after the placement. The gripping and moving device can move other hollow bodies during the supply of the cleaning fluid to the outer hollow body surface. The gripping and moving device can in particular perform different work and thus be used more effectively when the cleaning in the cleaning device takes a very long time.

Nitrogen or compressed air, and particularly preferably extreme clean dried air, also called XCDA, can be used as the cleaning fluid, for example. However, it is also possible to use water.

In accordance with a further embodiment, the supply device can comprise a number of discharge nozzles facing the cleaning space or opening into the cleaning space. The use of discharge nozzles makes it possible to impart a specific direction of flow to the cleaning fluid, whereby it can be achieved that the complete outer hollow body surface has the cleaning fluid applied. An effective and thorough cleaning of the outer hollow body surface is hereby achieved.

In a further developed embodiment, the discharge nozzles arranged in the side wall can comprise or be formed by passage holes. The construction space required is hereby kept small. In addition, the passage holes can be arranged distributed over the whole side wall so that the cleaning fluid can be evenly introduced into the cleaning space.

In a further developed embodiment,
the supply device can have passage holes arranged in the side wall; and
the discharge nozzles can be fastened to the side wall in fluid communication with the passage holes and can open into the cleaning space.

In this embodiment, the discharge nozzles are arranged in the cleaning space and are in fluid communication with the passage holes. The cleaning fluid consequently first flows through the passage holes and subsequently through the discharge nozzles. The discharge nozzles can be conducted relatively closely to the hollow body. The cleaning fluid can hereby be directed onto specific portions of the outer hollow body surface in a very targeted manner, for example onto those portions that experience has shown to be more contaminated and/or more difficult to access than other portions. A contribution to the thorough cleaning of the outer hollow body surface can also hereby be made.

In a further embodiment, the supply device can comprise a number of supply channels that are in communication with the discharge nozzles and by which the cleaning fluid can be conducted to the discharge nozzles. In principle, every discharge nozzle can be connected to their own supply channel; however, this is associated with a correspondingly high apparatus effort. In this embodiment, one supply channel can be connected to a plurality of discharge nozzles so that the apparatus effort falls.

A further developed embodiment can be characterized in that the supply channels are fastened to the side wall and are in communication with the passage holes. Since the side walls are anyway required to delimit the cleaning space, the former can also be used to receive the supply channels in this embodiment. An additional fastening of or reception for the supply channels can be dispensed with so that the construction space and the apparatus effort can be kept small.

In accordance with a further embodiment, the supply device can have a number of first discharge nozzles for supplying a first cleaning fluid and a number of second discharge nozzles for supplying a second cleaning fluid into the cleaning space. In this embodiment, the outer hollow body surface can, for example, first be cleaned by s first cleaning fluid, in particular water, and subsequently by a second cleaning fluid, in particular by air. The air then also has a drying effect. The cleaning result can hereby be improved. It is, however, also possible in dependence on the hollow body to be cleaned only to use the first cleaning fluid or only the second cleaning fluid without the cleaning device having to be modified for this purpose.

It may be suitable in a further embodiment that the cleaning device has a number of guide plates that are arranged in the cleaning space or that cooperate with it for guiding the cleaning fluid within the cleaning space. As stated with respect to the discharge nozzles, it is also possible with the guide plates to impart a specific flow to the cleaning fluid within the cleaning space. It can also be achieved by the guide plates that the cleaning fluid reaches the whole outer hollow body surface and/or is directed more to typically more contaminated or difficult to access portions.

In a further developed embodiment, the guide plates can be adjustable by means of a drive unit. The flow of the cleaning fluid can be adapted to differently shaped hollow bodies due to the adjustment possibility of the guide plates. In addition, a certain dynamism can be imparted to the flow of the cleaning fluid through the cleaning space, whereby the cleaning effect can likewise be improved.

In a further embodiment, the cleaning device has a closure unit by which the device opening can be at least partially closed. The device opening is in particular closed when the cleaning fluid is applied to the outer hollow body surface.

The uncontrolled discharge of the cleaning fluid can be prevented or limited by the closure unit, in particular when a gaseous fluid such as nitrogen or compressed air is used. The closure unit can be formed in the manner of a covering that closes the device opening. The covering here can be configured such that it also at least largely closes the device opening when the gripping and moving device projects into the cleaning space during the supply of the cleaning fluid. For this purpose, for example, the covering can have a plurality of closable parts that can be moved very closely to the gripping and moving device when the hollow bodies fastened to the latter project into the cleaning space. If the cleaning device has a placement device onto which the hollow bodies can be placed, the gripping and moving device can be separated from the hollow body when the cleaning fluid is applied to the outer hollow body surface. The closure unit can then close the whole device opening.

In a further embodiment, the cleaning device has at least one discharge opening that is in communication with the cleaning space and through which the cleaning fluid or the first cleaning fluid and the second cleaning fluid can be drained from the cleaning space. A controlled flow can hereby be generated within the cleaning space without greater turbulence and the formation of dead spaces on the outer hollow body surface occurring in which the cleaning fluid cannot act or can only act insufficiently on the outer hollow body surface. In addition, the cleaning fluid charged with the particles is drained from the cleaning device in a controlled manner so that these particles cannot again accumulate on the outer hollow body surface.

An embodiment of the invention relates to a treatment device for treating pot-shaped hollow bodies, in particular transport containers for semiconductor wafers or for lithography masks, comprising
a boundary wall that surrounds an inner space;
a gripping and moving device arranged in the inner space for moving the hollow body within the inner space; and
a wall opening that is formed by the boundary wall and through which the inner space is accessible;
at least one treatment unit for treating the hollow body; and
a closing device in accordance with one of the preceding embodiments, wherein
the hollow body closed by the cover is connected to the gripping and moving device during the supply of the cleaning fluid and
   is introduced into the cleaning space,
   is removed from the cleaning space, and
   is held in the cleaning space by the gripping and moving device during the supply of the cleaning fluid.

The technical effects and advantages that can be achieved with the treatment device in accordance with the proposal correspond to those that have been discussed for the present cleaning device. It must be pointed out in summary that the outer hollow body surface can be cleaned without the cover having to be separated from the remaining hollow body, whereby time can correspondingly be saved. The cleaning of the outer hollow body surface can furthermore take place when the gripping and moving device is connected to the hollow body (“on the fly”). A placement in a defined position is therefore not necessary. The gripping and moving device can move, for example pivot and/or rotate, the hollow body within certain limits during the cleaning of the outer hollow body surface so that the cleaning fluid used can also reach points that are difficult to access.

Where desired, the cleaning device can be provided with a placement device on which the hollow body closed by the cover can be placed. The connection between the hollow body and the gripping and moving device can be released after the placement. The gripping and moving device can move other hollow bodies during the supply of the cleaning fluid to the outer hollow body surface. The gripping and moving device can in particular perform different work and thus be used more effectively when the cleaning in the cleaning device takes a very long time.

Provision can be made in a further embodiment that the gripping and moving device has a cover unit for the at least partial covering of the device opening during the supply of the cleaning fluid. The cover unit can, for example, have extendable or foldable plates that cover the device opening when the cleaning fluid is applied to the outer hollow body surface. The uncontrolled discharge of the cleaning fluid from the cleaning space can hereby be avoided. The likelihood that the particles released from the outer hollow body surface with the cleaning fluid can enter into the inner space and can there again accumulate on the outer hollow body surface or also at the inner hollow body surface is hereby in particular reduced.

A further developed embodiment can provide that the treatment device has a drainage channel for draining the cleaning fluid or the first cleaning fluid and the second cleaning fluid, with the drainage channel in communication with the discharge opening. In this embodiment, the cleaning fluid charged with the particles released from the outer hollow body surface is drained from the treatment device so that these particles cannot again accumulate on the outer hollow body surface or on the inner hollow body surface.

In accordance with a further developed embodiment, a particle measuring device can be arranged in the drainage channel for determining the number of the particles in the drained cleaning fluid, in the drained first cleaning fluid, and/or in the drained second cleaning fluid. The number of the particles contained in the drained cleaning fluid can be determined by the particle measuring device, whereby a statement can be made on the progress of the cleaning process. The number of particles typically falls as the cleaning time increases. A limit value with respect to the number of particles can be defined. As soon as this limit value is fallen below, the cleaning process of the outer hollow body surface can be terminated. A specific degree of cleaning with respect to the outer hollow body surface can hereby be fixed. Excessively long cleaning processes can be avoided.

A further embodiment specifies that the cleaning device comprises a temperature control unit for controlling the temperature of the cleaning fluid applied to the outer hollow body surface. The temperature control unit can be integrated into the supply device so that the cleaning fluid is heated or cooled accordingly on its way into the cleaning space. Due to the temperature changes, there is an expansion and contraction of the hollow body and the particles adhering to the outer surface of the hollow body. However, since the particles generally have a different coefficient of linear expansion than the hollow body, relative movements occur between the particles and the outer hollow body surface, which promotes the detachment of the particles from the outer hollow body surface. The cleaning process is thereby promoted.

According to a further embodiment, the placement device is rotatably mounted about a rotation axis and is rotatable by means of a drive motor. The rotational speed at which the hollow body deposited on the placement device can be rotated can be selected to be so high that residues of the cleaning fluid still adhering to the outer surface of the hollow body are flung outwards due to the centrifugal force then acting. This is particularly helpful when water or another liquid is used as the cleaning fluid. The removal of the cleaning fluid from the outer surface of the hollow body is hereby supported.

An embodiment of the invention relates to a method of cleaning pot-shaped hollow bodies, in particular transport containers for semiconductor wafers or for lithography masks, using a treatment device in accordance with one of the previously discussed embodiments, said method comprising the following steps:
introducing the hollow body closed by the cover into the cleaning space by the gripping and moving device; and
supplying a cleaning fluid to the outer hollow body surface of the hollow body closed by the cover by means of the supply device, wherein the hollow body is connected to the gripping and moving device during the supply of the cleaning fluid and is held by it in the cleaning space.

The technical effects and advantages that can be achieved with the present method correspond to those that have been discussed for the present cleaning device. It must be pointed out in summary that the outer hollow body surface can be cleaned with a cover fastened to the hollow body. To this extent, the necessity of separating the cover from the remaining hollow body for this purpose is dispensed with, whereby time can correspondingly be saved. The cleaning of the outer hollow body surface can furthermore take place when the gripping and moving device is connected to the hollow body (“on the fly”). A placement in a defined position is therefore not necessary. The gripping and moving device can move the hollow body within certain limits during the cleaning of the outer hollow body surface so that the cleaning fluid used can also reach points that are difficult to access.

Exemplary embodiments of the invention will be explained in more detail in the following with reference to the enclosed drawings. There are shown

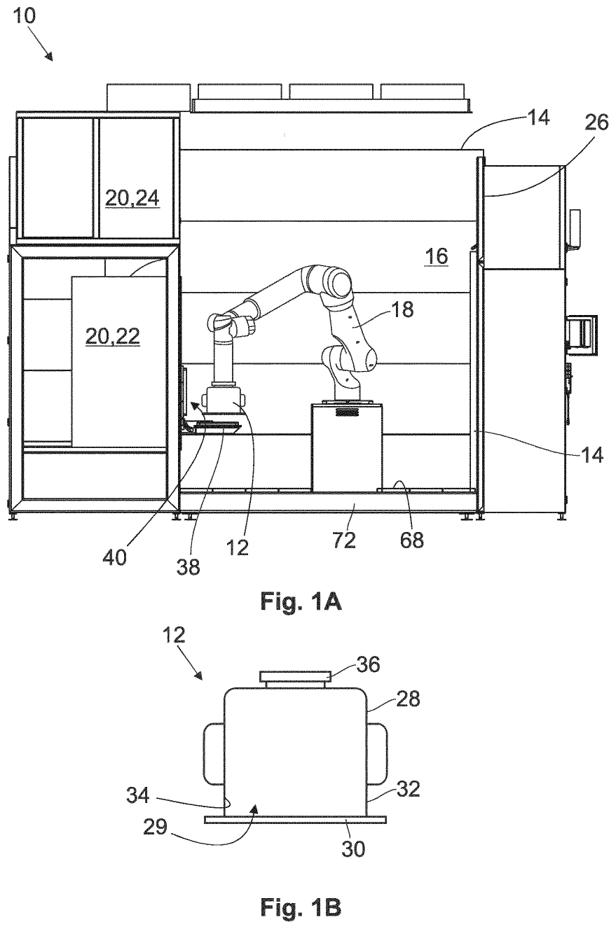

FIG. 1A a basic side view of a treatment device such as is known from the prior art;

FIG. 1B a separate, basic representation of a hollow body to be treated;

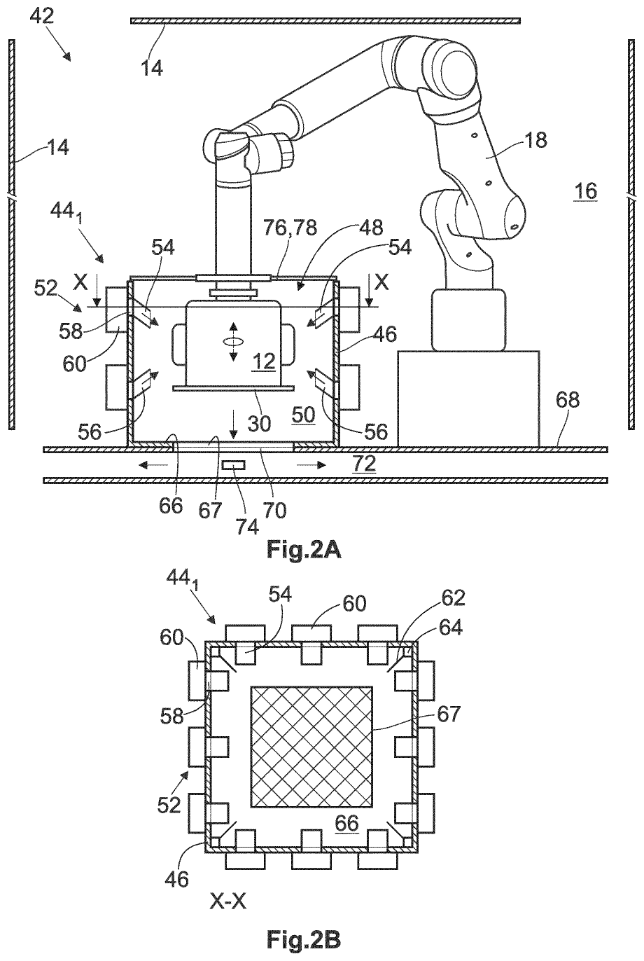

FIG. 2A a greatly simplified basic representation of a treatment device in accordance with the proposal that has a first embodiment of a cleaning device in accordance with the invention;

FIG. 2B a separate basic representation of the first embodiment shown in FIG. 2A of the cleaning device along the sectional plane X-X defined in FIG. 2A;

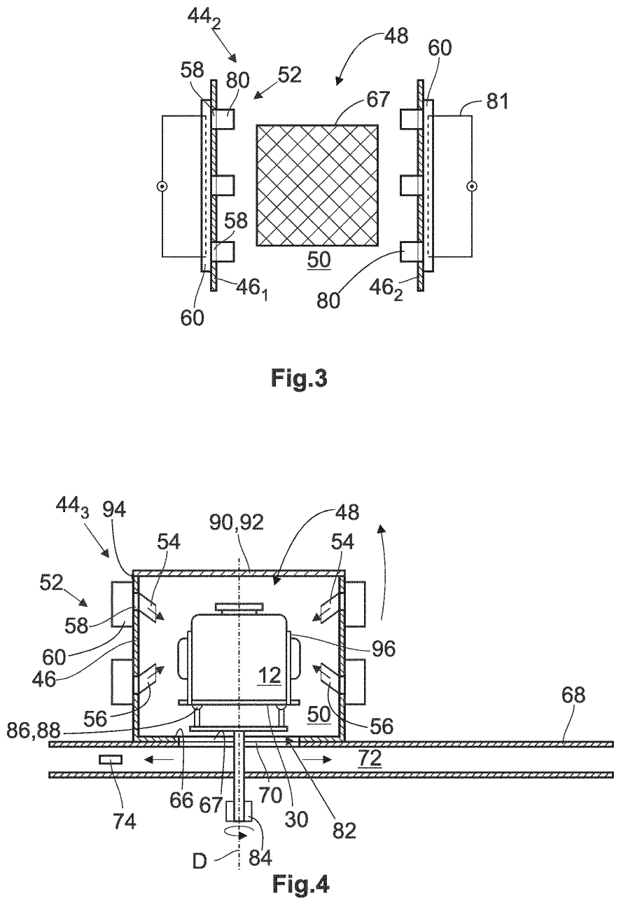

FIG. 3 a basic plan view of a second embodiment of the cleaning device in accordance with the invention analog to the representation selected in FIG. 2B; and

FIG. 4 a basic side representation of a third embodiment of the cleaning device analog to the representation selected in FIG. 2A.

A treatment device 10 known from the prior art for treating pot-shaped hollow bodies 12 is shown in simplified form in FIG. 1A. FIG. 1B shows a separate representation of the hollow body 12. The treatment device 10 comprises a boundary wall 14 that surrounds an inner space 16. A gripping and moving device 18 is provided in the inner space 16 by which the hollow bodies 12 to be treated can be moved in the inner space 16. In addition, a number of treatment units 20 are located in the inner space 16 that can, for example, be configured in the form of a washing device 22 and/or an evacuation device 24.

The boundary wall 14 forms a wall opening 26 that is closable in a manner not shown in any more detail and by which the inner space 16 is accessible.

The treatment device 10 is operated in the following manner: a hollow body 12 to be treated that has a hollow body wall 28 forms a hollow body opening 29 that can be closed by a cover 30 and forms an outer hollow body surface 32 and an inner hollow body surface 34 (see FIG. 1B) is transported to the wall opening 26 in a manner not shown in any more detail and is transported such that the gripping and moving device 18 can grip the hollow body 12 using a correspondingly formed interface 36 and can move it within the inner space 16. The hollow body 12 is supplied to the washing device 22 by the gripping and moving device 18. A cover handling unit 38 is shown in FIG. 1A by which the cover 30 can be connected to and separated from the remaining hollow body 12. The cover handling unit 38 is subsequently rotated by approximately 90° together with the cover 30 and as a consequence closes a process space opening 40 of the washing device 22. The hollow body 12 separated from the cover 30 is introduced into the washing device 22 by a further process space opening not shown here. A washing fluid, in particular water, is applied to the inner hollow body surface 34 and the cover 30 in the washing device 22. Depending on the configuration of the washing device 22, it is also possible to apply the washing fluid to the outer hollow body surface 32.

After the end of the washing procedure, the hollow body 12 is removed from the washing device 22 by the gripping and moving device 18, the cover handling unit 38 is rotated into the position shown in FIG. 1A, and the hollow body 12 is again connected to the cover 30.

The hollow body 12 is now supplied to the evacuation device 24 together with the cover 30. A procedure largely analog to that with the washing device 22 is followed for this purpose. The cover 30 is in particular first separated from the hollow body 12. A vacuum acting on the cover 30 and the hollow body 12 is applied in the evacuation device 24 and results in the evaporation of residues of the washing fluid used in the washing device 22.

Once this process has been terminated, the cover 30 is again connected to the hollow body 12 and is moved to the wall opening 26 by the gripping and moving device 18 and the cleaned hollow body 12 is expelled from the inner space 16 of the treatment device 10 together with the cover 30 and is transported onward. The hollow body 12 expelled from the inner space 16 can now be used to transport and store semiconductor wafers not shown here.

A treatment device 42 in accordance with the present invention is shown using a basic side view in FIG. 2A. The essential design of the treatment device 42 in accordance with the invention is here similar to that of the treatment device 10 in accordance with the prior art shown in FIG. 1A so that only the main differences will be looked at in the following.

The treatment device 42 in accordance with the invention is equipped with a cleaning device 44₁ in accordance with a first embodiment that serves the cleaning of the outer hollow body surface 32 of the hollow body 12 (see FIG. 1B). The cleaning device 44₁ is shown separately in FIG. 2B using a basic sectional representation along the sectional plane X-X defined in FIG. 2A; however, without the hollow body 12 and without any claim to completeness of the drawing or of its being true to scale. The cleaning device 44₁ comprises a side wall 46 that bounds a cleaning space 50 and that has a square cross-section in a plan view. The side wall 46 is consequently closed in the sectional plane X-X selected in FIG. 2B.

The side wall 46 forms at least one device opening 48 by which the hollow body 12 closed by the cover 30 for cleaning the outer hollow body surface 32 can be introduced into the cleaning space 50 by means of the gripping and moving device 18. The cleaning device 44₁ is furthermore equipped with a supply device 52 by which a cleaning fluid can be introduced into the cleaning space 50. In accordance with the first embodiment of the cleaning device 44₁, the supply device 52 comprises have a number of first discharge nozzles 54 for supplying a first cleaning fluid and a number of second discharge nozzles 56 for supplying a second cleaning fluid into the cleaning space 50. Consequently, two different cleaning fluids can be conveyed into the cleaning space 50, wherein the first cleaning fluid can, for example, be water and the second cleaning fluid can, for example, be air. Both the first discharge nozzles 54 and the second discharge nozzles 56 are in communication with passage holes 58 that pass through the side wall 46 and that are in turn connected to supply channels 60 that are likewise fastened to the side wall 46.

As can be recognized from FIG. 2B, a total of four guide plates 62 are arranged in the cleaning space 50 that can be moved by means of a drive unit 64. The guide plates 62 can, for example, be raised and lowered and/or rotated by the drive unit 64.

The treatment device 44₁ furthermore has a base wall 66 in which a discharge opening 67 is arranged The base wall 66 is placed onto a base 68 of the treatment device 42. The base 68 has a number of apertures 70 that open into a drainage channel 72 arranged therebelow (see also FIG. 1A). The cleaning device 44₁ is arranged such that the discharge opening 67 is in communication with the apertures 70. The cleaning fluid introduced into the cleaning space 50 through the discharge nozzles 54, 56 can be drained from the treatment device 42 through the discharge opening 67, the apertures 70, and the drainage channel 72.

A particle measuring device 74 is arranged in the drainage channel 72 by which the number of particles contained in the cleaning fluid can be determined.

The treatment device 44₁ is operated in the following manner: as already described with respect to FIG. 1A, the hollow body 12 to be treated is gripped by the gripping and moving device 18 so that the hollow body 12 can be moved to the inner space 16. Before the hollow body 12 is supplied to the washing device 22 by means of the gripping and moving device 18, the hollow body 12 is, as shown in FIG. 2A, introduced into the cleaning space 50 of the cleaning device 44₁ through the device opening 48. The connection between the hollow body 12 and the gripping and moving device 18 is maintained here. Nor is the cover 30 separated from the hollow body 12. It can likewise be seen from FIG. 2A that the gripping and moving device 19 dips a little into the cleaning space 50 to ensure that the total hollow body 12 is introduced into the cleaning space 50. Depending on the application case, it may also be advantageous to introduce the hollow body 12 only partially into the cleaning space 50. The gripping and moving device 18 then does not dip into the cleaning space 50.

As can be seen from a comparison FIGS. 1 and 2A, the gripping and moving device 18 of the treatment device 42 in accordance with the invention is equipped with a cover unit 76 by which the device opening 48 can be at least partially covered. The cover unit 76 can, for example, have extendable or foldable plates 78. The plates 78 can also serve as abutments and can abut the side wall 46 from above, whereby an end position of the hollow body 12 in the cleaning space 50 can be defined and collisions of the hollow body 12, in particular with the base wall 66, can be avoided.

When the position shown in FIG. 2A has been reached, the first cleaning fluid is conveyed as a result of an activation of conveyor units, not shown, through the first discharge nozzles 54 and is applied to the outer hollow body surface 32, as marked by the arrows in FIG. 2A. The cover unit 76 prevents the first cleaning fluid from being able to reach the inner space 16 in an uncontrolled manner through the device opening 48. The hollow body 12 can be moved in the cleaning space 50 by the gripping and moving device 18 while the first cleaning fluid is applied to the outer hollow body surface 32. In this respect, an up and down movement, a rotational movement, a laterally directed movement, and/or a combination of these movements can be carried out. The movement can be selected largely freely as long as no collision occurs of the hollow body 12 with the cleaning device 44₁.

The first cleaning fluid sweeps over the outer hollow body surface 32 and removes particles accumulated thereon. The discharge nozzles 54, the cover unit 76, and the guide plates 62 impart a flow toward the discharge opening 67 on the first cleaning fluid as a result of which the first cleaning fluid charged with the particles is drained from the cleaning device 44₁ and the treatment device 42 through the discharge opening 67, the apertures 70, and the drainage channel 72. A given volume unit of the cleaning fluid passes through the particle measuring device 74 here by which the number of particles contained in the respective volume unit is determined. This determination is continued using subsequent volume units. As soon as a specific limit value of the specific number of particles is fallen below, the supply of the first cleaning fluid can be ended. The second cleaning fluid can subsequently be applied to the outer hollow body surface 32 through the second discharge nozzles 56. In this respect, a procedure analog to the first cleaning fluid is carried out. Once the supply of the second cleaning fluid has ended, the hollow body 12 is removed from the cleaning device 44₁ and, as described for FIG. 1A, is supplied to the washing device 22 and the evacuation device 24. Once the treatment steps described there have been ended, the hollow body 12 is moved to the wall opening 26 by the gripping and moving device 18 from where the cleaned hollow body 12 is expelled from the inner space 16 of the cleaning device 44₁ together with the cover 30 and is transported onward.

Alternatively, the hollow body 12 closed by the cover 30 can only be supplied to the cleaning device 44₁ once the treatment steps carried out in the washing device 22 and the evacuation device 24 have been terminated. It is also possible to supply the hollow body 12 closed by the cover 30 to the cleaning device 44₁ both before and after the treatment steps carried out in the washing device 22 and the evacuation device 24.

A second embodiment of the cleaning device 44₁ is shown with reference to a basic representation in FIG. 3. The essential design of the cleaning device 44₂ in accordance with the second embodiment corresponds here to that of the cleaning device 44₁ of the first embodiment so that only the differences will be looked at here. While the cleaning device 44₁ in accordance with the first embodiment has a closed side wall 46 having four portions, the cleaning device 44₂ in accordance with the second embodiment comprises a first side wall 46₁ and a second side wall 46₂ that extend in parallel and are arranged spaced apart from one another at the base 68 of the treatment device 42. The device opening 48 consequently does not only extend within the plane of the drawing of FIG. 3, but also perpendicular thereto. It is therefore possible to introduce the hollow body 12 into the cleaning space 50 not only from above, but also from the side. The movement of the gripping and moving device 18 required for this can be simplified. A base wall 66 does not have the cleaning device 44₂ in accordance with the second embodiment.

In addition, the cleaning device 44₂ in accordance with the second embodiment has a number of discharge nozzles 80 through which a cleaning fluid, air for example, can be introduced into the cleaning space 50. In the shown second embodiment, the discharge nozzles 80 of the first side wall 46₁ are in turn connected to a common supply channel 60 using the passage holes 58. The same applies correspondingly to the discharge nozzles 80 of the second side wall 46₂. A temperature control unit 81 is arranged in the common supply channel 60 by which the temperature of the cleaning fluid can be changed.

The volume flow through each discharge nozzle 54, 56 can be set individually with the cleaning device 44₁ in accordance with the first embodiment and can in particular be switched on or off earlier or later than with other discharge nozzles 54, 56, which is not provided with the cleaning device 44₂ in accordance with the second embodiment. However, the apparatus effort is simplified due to the common supply channel 60 in the second embodiment.

FIG. 4 shows a third embodiment of the cleaning device 44₃ in accordance with the invention analog to the representation selected in FIG. 2A. For reasons of clarity, components of the treatment device 42, in particular the gripping and moving device 18, are not shown. The cleaning device 44₃ in accordance with the third embodiment largely corresponds to the cleaning devices 44₁, 44₂ in accordance with the first and second embodiments so that only the essential differences will be looked at in the following.

The cleaning device 44₃ in accordance with the third embodiment is equipped with a placement device 82 on which the hollow body 12 can be placed. For this purpose, the hollow body 12 is introduced into the cleaning space 50 by the gripping and moving device 18 until the hollow body 12 comes into contact with the placement device 82. The contact between the gripping and moving device 18 and the hollow body 12 is subsequently separated.

In the embodiment of the cleaning device 44₃ shown, the hollow body 12 is placed on the placement device 82 with the cover 30, with it also being possible to place the hollow body 12 on the placement device 82 with the hollow body wall 28 (see FIG. 1B). The placement device 82 is arranged adjacent to the base wall 66 and has a frame structure having rod-like or bar-like carriers that is configured such that it impedes the flow of the cleaning fluid as little as possible. It is in particular ensured that the cover 30 can be easily acted on by the cleaning fluid. It may be suitable in this respect for the frame structure to provide three circular support points on which the hollow body 12 can be placed.

The placement device 82 can be fastened in the cleaning space 50. In the shown embodiment of the treatment device 42, the placement device 82 is, however, rotatably supported in the base 68 of the treatment device 42 and can be rotated about a rotation axis D by means of a drive motor 84. As a consequence of this rotation, the hollow body 12 placed on the placement device 82 can be rotated, whereby the supply of the cleaning fluid to points of the outer hollow body surface 32 that are difficult to access can be improved.

Not shown is an embodiment in which the aforementioned temperature control unit 81 (cf. FIG. 3) is provided to change the temperature of the supplied cleaning fluid.

The support points in the shown embodiment of the treatment device 42 are formed by downholders 88 that are formed as suction cups 86 and that serve the fixing of the hollow body 12 during the application of the cleaning fluid. The downholders 88 can also be formed in a different manner, for example in form of brackets. Fixing arms or the like that can engage the hollow body 12 from above or from the side can thus provide the fixing of the hollow body 12 during the application of the cleaning fluid (not shown).

As mentioned, the placement device 82 can be turned about the rotation axis D by means of the drive motor 84. In order to prevent the hollow body 12 from slipping on the placement device 82 as a result of imbalances or other reasons during rotation, retaining rods 96 are provided which come into contact or almost into contact with the hollow body wall 28 when the hollow body 12 is deposited on the placement device 82. The retaining rods 96 may also be connected to a net not shown here in a basket-like manner.

The cleaning device 44₃ in accordance with the third embodiment furthermore has a closure unit 90 by which the cleaning space 50 can be closed, in particular when the hollow body 12 is introduced into the cleaning space 50 and is to be acted on by the cleaning fluid. The closure unit 90, not shown here, has a closure body 92 that is rotatably fastened to the side wall 46 of the cleaning device 44₃ by a fastening means 94, not shown in any more detail. The fastening means 94 can comprise a hinge here. A setting device by which the closure unit 90 can be moved to open and close the device opening 48 can furthermore be provided, not shown.

The hollow body 12 is introduced into the cleaning space 50 by the gripping and moving device 18 and is placed on the placement device 82 when the closure unit 90 is in an open position (not shown). The downholders 88 are subsequently activated and the gripping and moving device 18 is separated from the hollow body 12. As soon as the gripping and moving device 18 has left the cleaning device 44₃, the closure unit 90 can be moved into the closed position as shown in FIG. 4. The cleaning fluid can now be applied to the outer hollow body surface 32. As mentioned, a first cleaning fluid, for example water, may be introduced into the cleaning chamber 50 through the first outlet nozzles 54 and a second cleaning fluid, for example air, may be introduced into the cleaning space 50 through the second discharge nozzles 56. The hollow body 12 may be rotated by the placement device 82 prior to or during the supply of the second cleaning fluid, at such a rate that water residues are flung away from the outer hollow body surface 32. The retaining rods 96 prevent the hollow body 12 from slipping away during the rotation.

On a terminated cleaning of the outer hollow body surface 32, the closure unit 90 is moved into the open position. The hollow body 12 is removed from the cleaning space 50 by the gripping and moving device 18 and is supplied for further treatment.

An embodiment of the closure unit 90 is not shown that can be set into the closed position even when the gripping and moving device 18 is still connected to the hollow body 12 (cf. FIG. 2A). The closure body 92 can have corresponding portions for this purpose and can be pushed onto the gripping and moving device 18.

The closure unit 90 has the effect that at least some of the cleaning fluid cannot exit the cleaning space 50 of the cleaning device 44₃ in an uncontrolled manner through the device opening 48.

While a change of the temperature of the supplied cleaning fluid can be provided in all shown embodiments of the cleaning device 44, the rotation of the hollow body 12 about its own axis for flinging away residues of the cleaning fluid from the outer hollow body surface 32 is only possible in the embodiment shown in FIG. 4. Although the hollow body 12 can also be rotated about its own axis with the gripping and moving device 18, i.e., when the hollow body 12 is connected to the gripping and moving device 18, the achievable rotational speed is too low to be able to remove residues of the cleaning fluid from the hollow body outer surface 32 to any appreciable extent.

### REFERENCE NUMERAL LIST

10 treatment device in accordance with the prior art
12 hollow body
14 boundary wall
16 inner space
18 gripping and moving device
20 treatment unit
22 washing device
24 evacuation device
26 wall opening
28 hollow body wall
29 hollow body opening
30 cover
32 outer hollow body surface
34 inner hollow body surface
36 interface
38 cover handling unit
40 process space opening
42 treatment device
44 cleaning device
44₁ cleaning device
44₂ cleaning device
44₃ cleaning device
46 side wall
46₁ first side wall
46₂ second side wall
48 device opening
50 cleaning space
52 supply device
54 first discharge nozzle
56 second discharge nozzle
58 passage hole
60 supply channel
62 guide plate
64 drive unit
66 base wall
67 discharge opening
68 base
70 aperture
72 drainage channel
74 particle measuring device
76 cover unit
78 plate
80 discharge nozzle
81 temperature control unit
82 placement device
84 drive motor
86 suction cup
88 downholder
90 closure unit
92 closure body
94 fastening means
96 retaining rods
D rotation axis

1-18. (canceled)

19. A device for cleaning pot-shaped hollow bodies, semiconductor wafers and/or lithography masks, comprising:
at least one side wall that bounds a cleaning space, wherein the side wall forms at least one device opening by which a hollow body is introduced into the cleaning space by a gripping and moving device, wherein the hollow body has a hollow body wall that forms a hollow body opening that is closed by a cover and forms an outer hollow body surface; and
at least one supply device for supplying a cleaning fluid to the outer hollow body surface of the hollow body closed by the cover, wherein the device opening is configured such that the gripping and moving device projects at least partially into the cleaning space or terminates flush with the device opening at least during the supply of the cleaning fluid.

20. The cleaning device of claim 19, wherein the supply device comprises a number of discharge nozzles facing the cleaning space or opening into the cleaning space.

21. The cleaning device of claim 20, wherein the discharge nozzles arranged in the side wall comprise or are formed by passage holes.

22. The cleaning device of claim 20, wherein the supply device has passage holes arranged in the side wall; and the discharge nozzles are fastened to the side wall in fluid communication with the passage holes and open into the cleaning space.

23. The cleaning device of claim 20, wherein the supply device comprises a number of supply channels that are in communication with the discharge nozzles and by which the cleaning fluid is conducted to the discharge nozzles.

24. The cleaning device of claim 22, wherein the supply channels are fastened to the side wall and are in communication with the passage holes.

25. The cleaning device of claim 21, wherein the supply device has a number of first discharge nozzles for supplying a first cleaning fluid and a number of second discharge nozzles for supplying a second cleaning fluid into the cleaning space.

26. The cleaning device of claim 19, wherein the cleaning device has a number of guide plates that are arranged in the cleaning space or that cooperate with it for guiding the cleaning fluid within the cleaning space.

27. The cleaning device of claim 26, wherein the guide plates are adjustable by means of a drive unit.

28. The cleaning device of claim 19, wherein the cleaning device has a closure unit by which the device opening is at least partially closable.

29. The cleaning device of claim 19, wherein the cleaning device has at least one discharge opening that is in communication with the cleaning space and through which the cleaning fluid or the first cleaning fluid and the second cleaning fluid is drained from the cleaning space.

30. The cleaning device of claim 19, wherein the cleaning device comprises a temperature control unit for controlling the temperature of the cleaning fluid applied to the outer hollow body surface.

31. The cleaning device of claim 19, further comprising a placement device that is arranged in the cleaning space on which the gripping and moving device places the hollow body closed by the cover for supplying the cleaning fluid, wherein the placement device is rotatably mounted about a rotation axis and is rotatable a drive motor.

32. A treatment device for treating pot-shaped hollow bodies, containers for semiconductor wafers or for lithography masks, comprising:
a boundary wall that surrounds an inner space;
a gripping and moving device arranged in the inner space for moving the hollow body within the inner space;
a wall opening that is formed by the boundary wall and through which the inner space is accessible;
at least one treatment unit for treating the hollow body;
a cleaning device, comprising at least one side wall that bounds a cleaning space, wherein the side wall forms at least one device opening by which a hollow body is introduced into the cleaning space by a gripping and moving device, wherein the hollow body has a hollow body wall that forms a hollow body opening that is closed by a cover and forms an outer hollow body surface; and
at least one supply device for supplying a cleaning fluid to the outer hollow body surface of the hollow body closed by the cover, wherein the device opening is configured such that the gripping and moving device projects at least partially into the cleaning space or terminates flush with the device opening at least during the supply of the cleaning fluid,
wherein the hollow body is closed by a cover and connected to the gripping and moving device during the supply of the cleaning fluid and is introduced into the cleaning space, is removed from the cleaning space, and is held in the cleaning space by the gripping and moving device during the supply of the cleaning fluid, wherein the device opening is configured such that the gripping and moving device projects at least partially into the cleaning space or terminates flush with the device opening at least during the supply of the cleaning fluid.

33. The treatment device of claim 32, wherein the gripping and moving device has a cover unit for the at least partial covering of the device opening during the supply of the cleaning fluid.

34. The treatment device of claim 32, wherein the treatment device has a drainage channel for draining the cleaning fluid or the first cleaning fluid and the second cleaning fluid, with the drainage channel being in communication with the discharge opening.

35. The treatment device of 32, wherein a particle measuring device is arranged in the drainage channel for determining the number of the particles in the drained cleaning fluid, in the drained first cleaning fluid, and/or in the drained second cleaning fluid.

36. A method for cleaning pot-shaped hollow bodies and/or transport containers for semiconductor wafers or for lithography masks, said method comprising:
introducing a hollow body into a cleaning space by a gripping and moving device, wherein the hollow body has a hollow body wall that forms a hollow body opening that is closed by a cover and forms an outer hollow body surface; and
supplying a cleaning fluid to the outer hollow body surface of the hollow body closed by the cover by a supply device, wherein the hollow body is connected to the gripping and moving device during the supply of the cleaning fluid and held by the gripping and moving device in the cleaning space.
